(19) United States
(12) Patent Application Publication
(10) Pub. No.: US 2011/0043506 A1
(43) Pub. Date: Feb. 24, 2011

(54) Device for Driving LCD panel and Related Display Device

(76) Inventor: Yu-Hsun Peng, Hsinchu County (TW)

Correspondence Address: NORTH AMERICA INTELLECTUAL PROPERTY CORPORATION, P.O. BOX 506, MERRIFIELD, VA, 22116, US

(21) Appl. No.: 12/774,732

(22) Filed: May 6, 2010

(30) Foreign Application Priority Data
Aug. 24, 2009 (TW) 098128370

(51) Int. Cl. G09G 3/36; G06F 3/038

(52) U.S. Cl. 345/211; 345/98

(57) ABSTRACT

A driving device for driving an LCD panel is disclosed. The LCD panel includes a substrate and a plurality of pixel units arranged as a matrix on the substrate. The driving device includes a gate driver for generating a plurality of scanning signals, each for driving pixel units of a row of the LCD panel, a voltage generator for providing a non-negative common signal to the substrate according to a conversion period, and a source driving device for generating a plurality of source driving signals according to a compensation indication signal, an frame signal and the conversion period, each source driving signal for driving pixel units of a column of the LCD panel.

### BACKGROUND OF THE INVENTION

1. Field of the Invention

The present invention is related to a driving device for driving a liquid crystal display (LCD) panel and related display device, and more particularly, to a driving device and related display device capable of relieving a flicker effect of the LCD panel by adjusting a source driving signal to simplify a power supply circuit thereof.

2. Description of the Prior Art

A liquid crystal display (LCD) monitor has characteristics of light weight, low power consumption, zero radiation, etc. and is widely used in many information technology (IT) products, such as computer systems, mobile phones, and personal digital assistants (PDAs). The operating principle of the LCD monitor is based on the fact that different twist states of liquid crystals result in different polarization and refraction effects on light passing through the liquid crystals. Thus, the liquid crystals can be used to control amount of light emitted from the LCD monitor by arranging the liquid crystals indifferent twist states, so as to produce light outputs at various brightnesses, and diverse gray levels of red, green and blue light.

Please refer to FIG. 1, which is a schematic diagram of a thin film transistor (TFT) LCD monitor 10 of the prior art. The LCD monitor 10 includes an LCD panel 100, a source driver 102, a gate driver 104 and a voltage generator 106. The LCD panel 100 is composed of two substrates, and space between the substrates is filled with liquid crystal materials. One of the substrates is installed with a plurality of data lines 108, a plurality of scan lines (or gate lines) 110 and a plurality of TFTs 112, and another substrate is installed with a common electrode for providing a common signal Vcom outputted by the voltage generator 106. The TFTs 112 are arranged as a matrix on the LCD panel 100. Accordingly, each data line 108 corresponds to a column of the LCD panel 100, each scan line 100 corresponds to a row of the LCD panel 100, and each TFT 112 corresponds to a pixel. Note that the LCD panel 100 composed of the two substrates can be regarded as an equivalent capacitor 114.

The source driver 102 and the gate driver 104 input signals to the corresponding data lines 108 and scan lines 110 based upon a desired image data, to control whether or not to enable the TFT 112 and a voltage difference between two ends of the equivalent capacitor 114, so as to change alignment of the liquid crystals as well as the penetration amount of light. As a result, the desired image data can be correctly displayed on the LCD panel 100. However, the longer a positive (or negative) voltage is applied to the liquid crystals, the weaker the polarization and refraction effects on light, causing a decline in image quality. Therefore, in order to prevent the liquid crystals from being damaged by the driving voltage, positive and negative voltages are alternated to drive the liquid crystals. Additionally, other than the equivalent capacitor 114, the LCD panel 100 further includes parasitic capacitors. That is, once the image data is consecutively displayed on the LCD panel 100, the parasitic capacitors result in a residual image effect due to stored charges, and thus affect later image frames. Thus, the alternated +/− voltages are further required to relieve the residual image effect caused by the parasitic capacitors.

However, when the pixels are driven by the alternated +/− voltages, image frames on the LCD monitor 10 will be influenced by a flicker caused by voltage offsets of the TFTs 112. For that reason, various driving methods, such as line inversion, are employed to compensate the flicker on the LCD panel 100 in the prior art. More specifically, please refer to FIG. 2, which is a time-variant schematic diagram of the common signal Vcom and a source driving signal VS_x. If desiring to drive the LCD panel 100 by the alternated +/− voltages, the source driver 102 has to select a proper voltage level to be the source driving signal VS_x based upon the image data, and periodically converts the source driving signal VS_x based upon a conversion period signal. In addition, the voltage generator 106 has to adjust the common signal Vcom based upon amplitude of the flicker to compensate the flicker, and periodically convert the common signal Vcom based upon the conversion period signal. As a result, voltage differences ΔV+, ΔV− between two ends of the equivalent capacitor 114 can exactly drive the liquid crystals to correctly display the image data. In other words, the power supply circuit (not shown in FIG. 1) of the LCD monitor 10 has to provide various positive and negative voltage levels at any moment, implying that architecture of the power supply circuit is very complex, such that the cost of the LCD monitor 10 can not be effectively reduced.

Therefore, how to modify the driving method, such that a simpler power supply circuit can be employed in the driving device to drive the LCD monitor with the alternated +/− voltages, has been a major objective of the industry.

### SUMMARY OF THE INVENTION

It is therefore a primary objective of the claimed invention to provide a driving device for driving a LCD panel and related display device.

The present invention discloses a driving device for driving an LCD panel. The LCD panel comprises a substrate and a plurality of pixel units arranged as a matrix on the substrate. The driving device comprises a gate driver coupled to the plurality of pixel units for generating a plurality of scanning signals, each for driving pixel units of a row of the LCD panel, a voltage generator coupled to the substrate for providing a non-negative common signal to the substrate according to a conversion period signal, and a source driver coupled to the LCD panel for generating a plurality of source driving signals according to a compensation indication signal, a frame signal and the conversion period signal, each source driving signal for driving pixel units of a column of the LCD panel, wherein the compensation indication signal is utilized for indicating whether to compensate a flicker amplitude of the plurality of pixel units.

The present invention further discloses a display device comprising an LCD panel comprising a substrate, and a plurality of pixel units arranged as a matrix on the substrate, a color analyzer coupled to the LCD panel for measuring a flicker amplitude of the plurality of pixel units to generate a compensation indication signal, a timing controller for receiving image data to generate a frame signal and a conversion period signal, and a driving device for driving the LCD panel, the driving device comprising, a gate driver coupled to the plurality of pixel units for generating a plurality of scanning signals, each for driving pixel units of a row of the LCD panel, a voltage generator coupled to the substrate and the timing controller for providing a non-negative common signal to the substrate according to the conversion period signal, and a source driver coupled to the color analyzer, the timing controller and the LCD panel for generating a plurality of source driving signals according to the compensation indication signal, the frame signal and the conversion period signal, each of the plurality of source driving signals for driving pixel units of a column of the LCD panel.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a TFT LCD monitor of the prior art.

FIG. 2 is a time-variant schematic diagram of a common signal and a source driving signal of the TFT LCD monitor shown in FIG. 1.

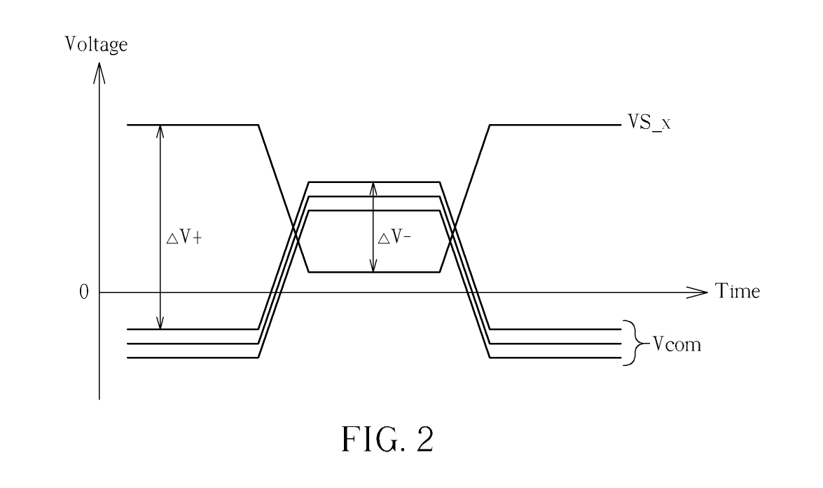

FIG. 3 is a schematic diagram of a driving device according to an embodiment of the present invention.

FIG. 4 is a time-variant schematic diagram of a common signal and a source driving signal of the driving device shown in FIG. 3.

FIG. 5 is a schematic diagram of a source driver of the driving device shown in FIG. 3.

FIG. 6 is a schematic diagram of a gamma voltage generator of the source driver shown in FIG. 5.

FIG. 7A and FIG. 7B are schematic diagrams of voltages levels of signals related to the source driver shown in FIG. 5.

FIG. 8 is a schematic diagram of a voltage generator of the driving device shown in FIG. 3.

FIG. 9 is a schematic diagram of a display device according to an embodiment of the present invention.

### DETAILED DESCRIPTION

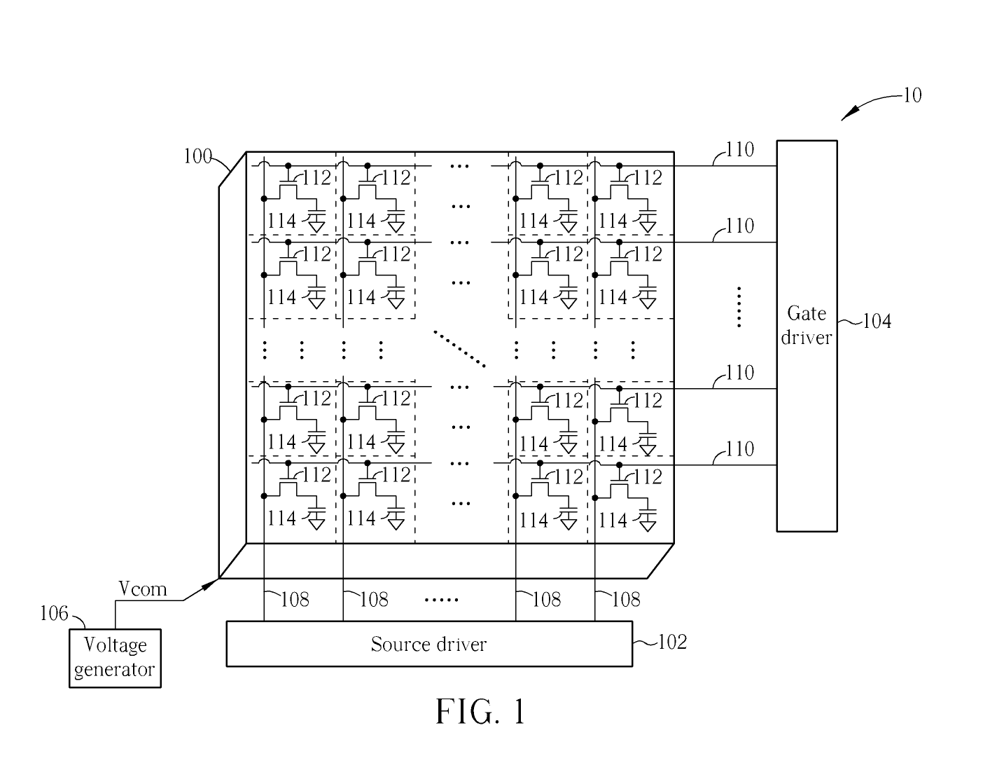

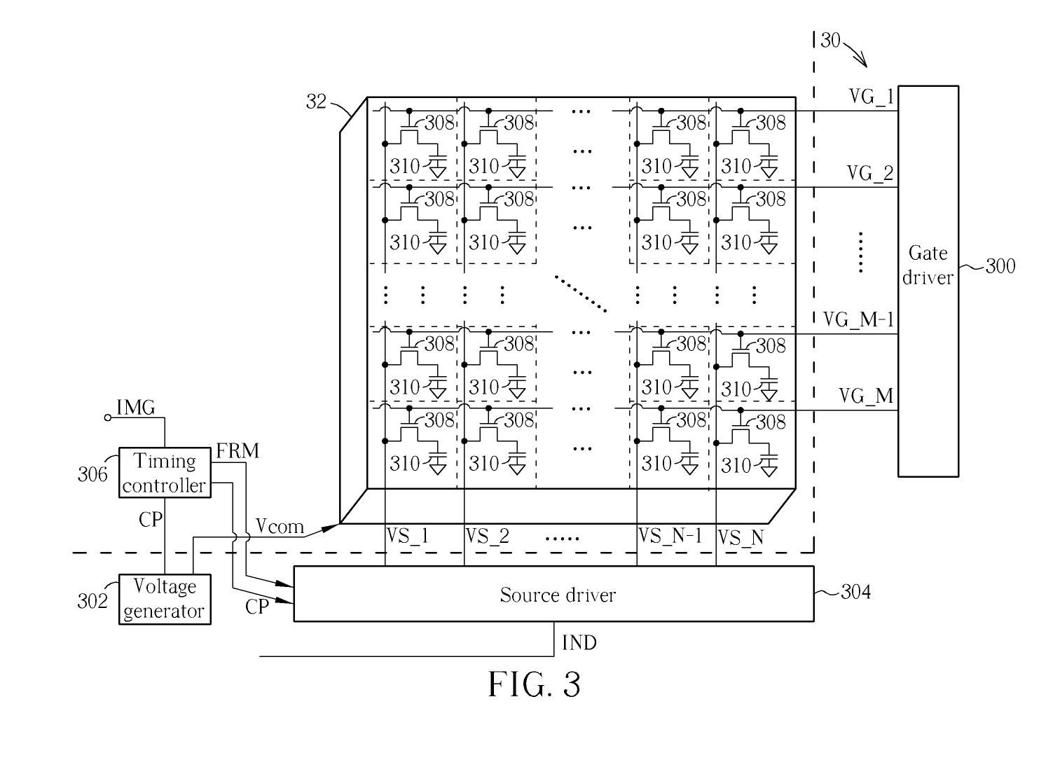

Please refer to FIG. 3, which is a schematic diagram of a driving device 30 according to an embodiment of the present invention. The driving device 20 is utilized for driving a liquid crystal display (LCD) panel 32 according to signals outputted by a timing controller 306, and includes a gate driver 300, a voltage generator 302 and a source driver 304. Architecture and operations of the LCD panel 32 are similar to the LCD panel 100 shown in FIG. 1. More specifically, the LCD panel 32 includes M×N pixel units arranged as a matrix on a substrate. Each pixel unit can be regarded as an equivalent capacitor 310, and terminal voltages thereof are controlled by a thin film transistor (TFT) 308 to display a desired gray level. Note that the timing controller 306 is utilized for receiving image data IMG to generate a frame signal FRM and a conversion period signal CP. The gate driver 300 generates scanning signals VG_1-VG_M to determine an update sequence of pixel units of a row of the LCD panel 32. The voltage generator 302 provides a non-negative common signal Vcom to the substrate of the LCD panel 32 according to the conversion period signal CP. The source driver 304 generates source driving signals VS_1-VS_N according to a compensation indication signal IND, the frame signal FRM and the conversion period signal CP, to drive pixel units of a column of the LCD panel 32. Note that the compensation indication signal IND is utilized for indicating whether or not to compensate a flicker amplitude of the pixel units.

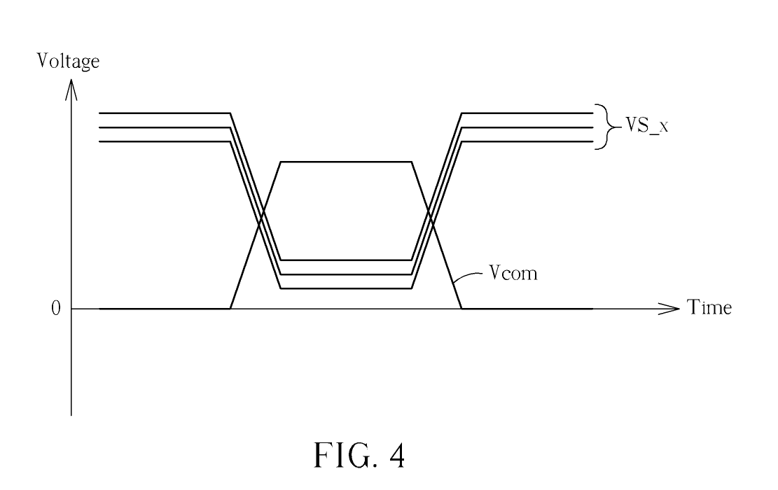

In short, in the driving device 30, the source driver 304 takes over partial functions of the voltage generator 302 compared to the prior art. That is, the source driver 304 compensates the flicker amplitude of the LCD panel 32 according to the compensation indication signal IND, and simultaneously selects desired voltage levels to be the source driving signal VS_1-VS_N according to the frame signal FRM, such that a voltage difference between two ends of the equivalent capacitor 310 can correctly drive corresponding liquid crystals to display the image data IMG. As a result, the voltage generator 302 no longer has to adjust the common signal Vcom, but only has to provide the common signal Vcom functionally similar to traditional clock signals according to the conversion period signal CP, as illustrated in FIG. 4. In other words, the driving device 30 no longer has to provide any negative voltage to the LCD panel 32, such that a power supply circuit of a corresponding LCD monitor can be greatly simplified.

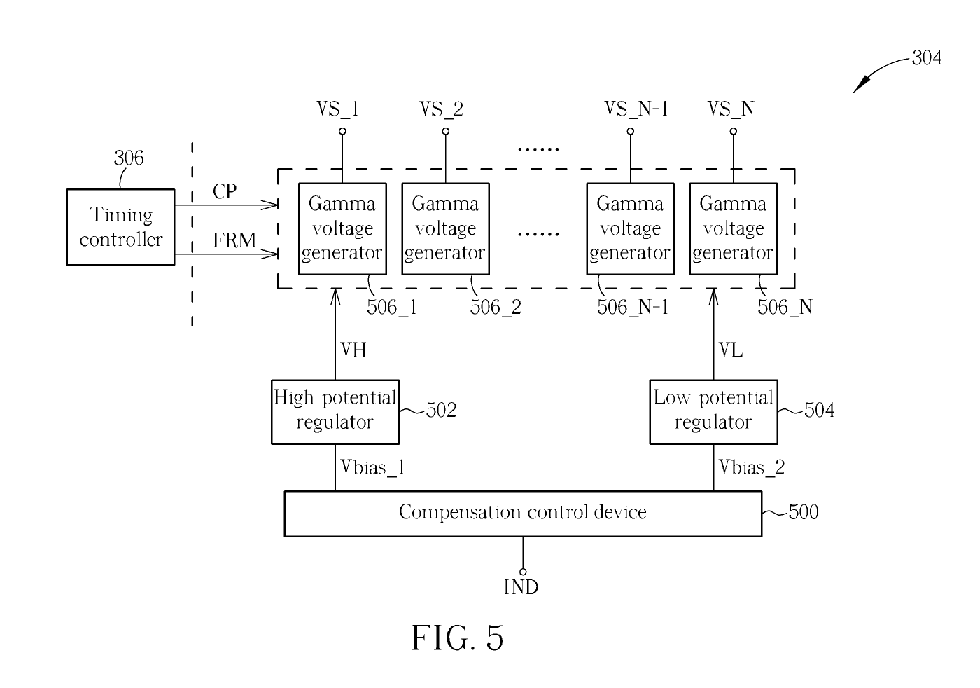

Please continue to refer to FIG. 5 for more details about the source driver 304. FIG. 5 is a schematic diagram of the source driver 304. The source driver 304 includes a compensation control device 500, a high-potential regulator 502, a low-potential regulator 504 and gamma voltage generators 506_1-506_N. The compensation control device 500 is utilized for generating a first bias signal Vbias1 and a second bias signal Vbias2 according to the compensation indication signal IND. Next, the high-potential regulator 502 adjusts and stabilizes a high-potential voltage VH based upon the first bias signal Vbias1, and the low-potential regulator 504 adjusts and stabilizes a low-potential voltage VL based upon the second bias signal Vbias2. Finally, the gamma voltage generators 506_1-506_N respectively generate the source driving signal VS_1-VS_N according to the high-potential voltage VH, the low-potential voltage VL, the conversion period signal CP and a corresponding pixel content signal in the frame signal FRM.

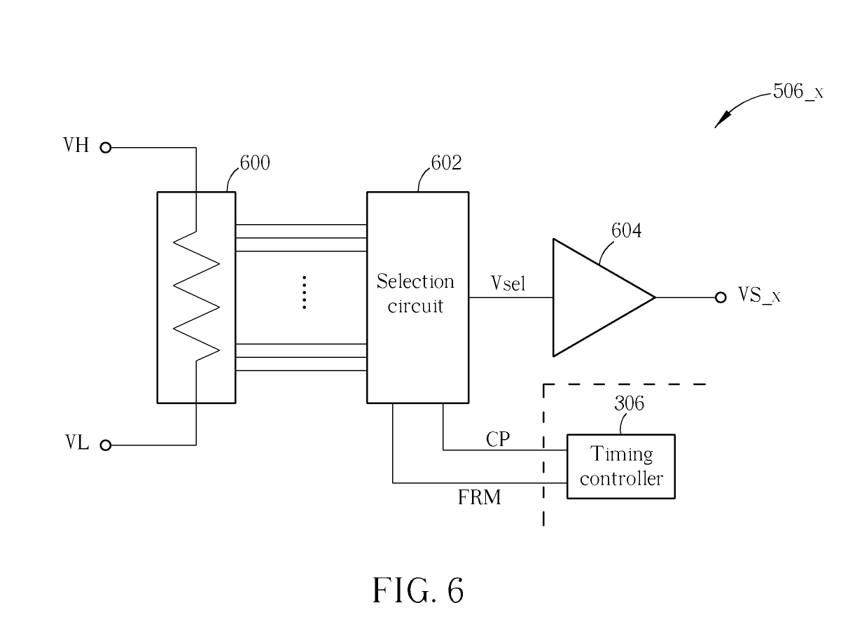

Please continue to refer to FIG. 6, which is a schematic diagram of any one of the gamma voltage generators 506_{—}x. The gamma voltage generator 506_{—}x includes a voltage divider 600, a selection circuit 602 and a first buffer amplifier 604. The voltage divider 600 generates a plurality of divided voltages according to the high-potential voltage VH and the low-potential voltage VL. Next, the selection circuit 602 periodically selects one of the plurality of divided voltages according to the pixel content signal, and converts the selected divided voltage according to the conversion period signal CP. That is, the selection circuit 602 alternately selects one of the divided voltages and a converted voltage corresponding to the selected divided voltage to generate a selection result Vsel. Finally, the first buffer amplifier 604 buffers the selection result Vsel to generate the corresponding source driving signal VS_x.

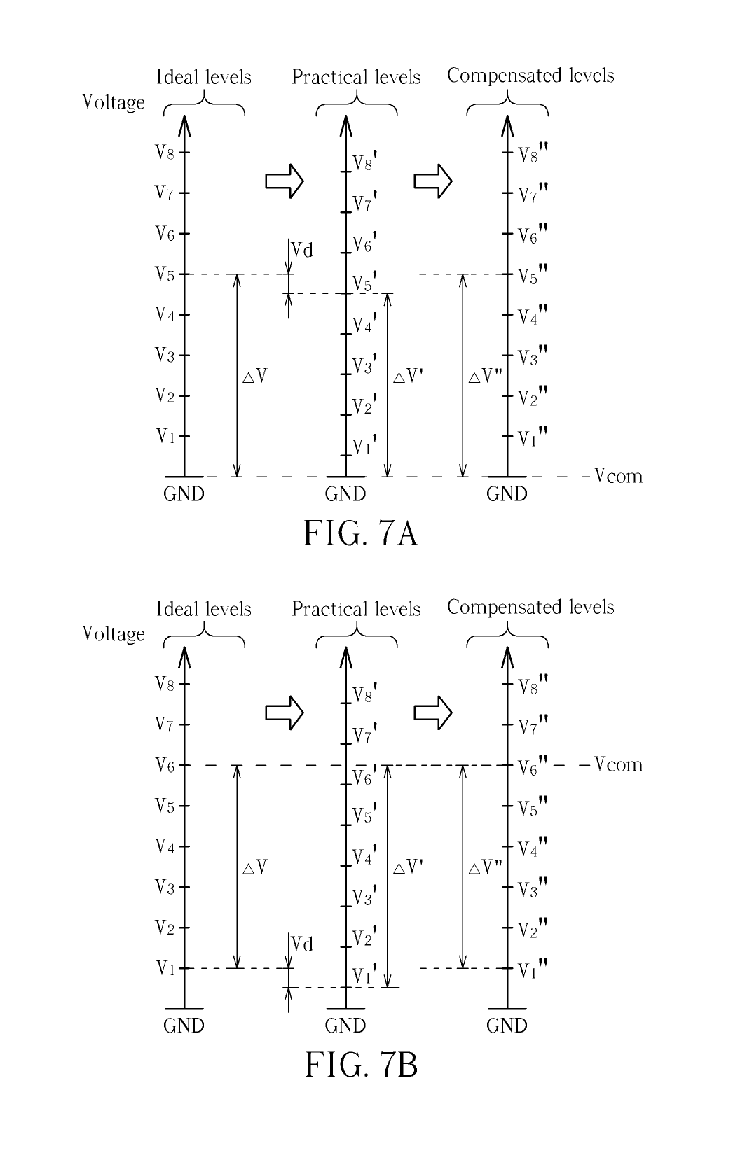

Several embodiments are given in the following to describe detailed operations of the source driver 304 and the gamma voltage generators 506_1-506_N compensating the flicker amplitude. Please refer to FIG. 7A, which is a schematic diagram of voltage levels of signals related to the source driver 304. In the simplest case (temporarily ignoring the conversion operation), preferably assume that the common signal Vcom is a ground voltage GND, the pixel units can display eight gray levels V₁-V₈, and the pixel content signal indicates that the source driving signal VS_x should display the gray level V₅, as illustrated in FIG. 7A. However, in practice, due to parasitic component effects of the TFT 308, the voltage difference between two ends of the equivalent capacitor 310 is equal to ΔV′=V₅−Vd, instead of the correct voltage difference ΔV=V₅. In such a situation, the compensation control device 500 can adjust the first bias signal Vbias1 and the second bias signal Vbias2 to simultaneously raise the high-potential voltage VH and the low-potential voltage VL, such that divided voltages V₁′-V₈′ provided by the dividing circuit 600 will increase to correct voltage levels V₁″-V₈″ to compensate the parasitic component effects. As a result, the compensated voltage difference ΔV″=V₅″=V₅ of the equivalent capacitor 310 is equal to the desired gray level. Please continue to refer to FIG. 7B for another embodiment in which the conversion operation is taken into consideration. If another state (high-potential state) of the common signal Vcom is equal to the gray level V₆, the selection circuit 602 should select the gray level V₁ to be the source driving signal VS_x, such that the voltage difference of the equivalent capacitor 310 is equal to ΔV=V₆−V₁=V₅−0 to guarantee a constant color of the pixel unit during the conversion operation. In practice, the voltage difference between two ends of the equivalent capacitor 310 is equal to ΔV′=V₆−V₁+Vd, instead of the correct voltage difference ΔV=V₆−V₁. Similarly, the compensation control device 500 can adjust the first bias signal Vbias1 and the second bias signal Vbias2 to raise the high-potential voltage VH and the low-potential voltage VL, to increase the uncompensated gray levels V₁′˜V₈′ to the correct levels V₁″˜V₈″, so as to correctly display the desired color.

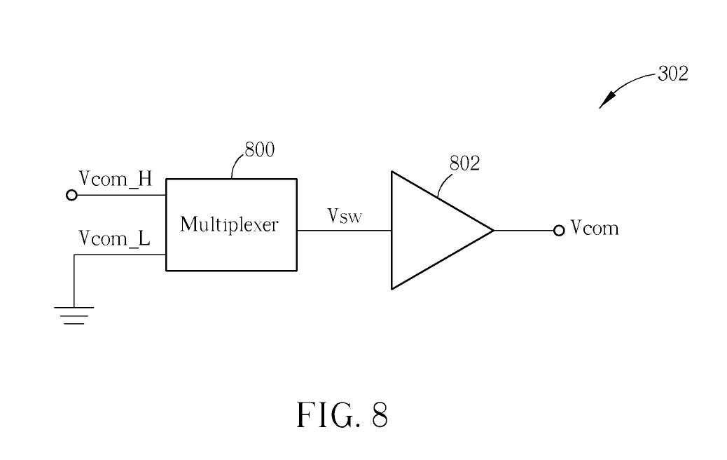

To implement the conversion operation, preferably, the voltage generator 302 can further include a multiplexer 800 and a second buffer amplifier 802, as illustrated in FIG. 8. The multiplexer 800 periodically selects a high-potential common voltage Vcom_H (e.g. the gray level V₆ shown in FIG. 7B) or a low-potential common voltage Vcom_L (e.g. the ground voltage GND shown in FIG. 7B) according to the conversion period signal CP to generate a switch signal Vsw. Next, the second buffer amplifier 802 buffers the switch signal Vsw to generate the common signal Vcom. As illustrated in FIG. 7A and FIG. 7B, one end of the multiplexer 800 can preferably be coupled to the ground, such that the low-potential common voltage Vcom_L is equal to the ground voltage GND, so as to simplify the required power supply circuit.

Note that if the compensation indication signal IND indicates that the flicker amplitude exceeds a default threshold (e.g. ±2%), the source driver 304 compensates the flicker amplitude; else, the flicker amplitude may be ignored since the human visual system is inattentive to the flicker amplitude within the default threshold.

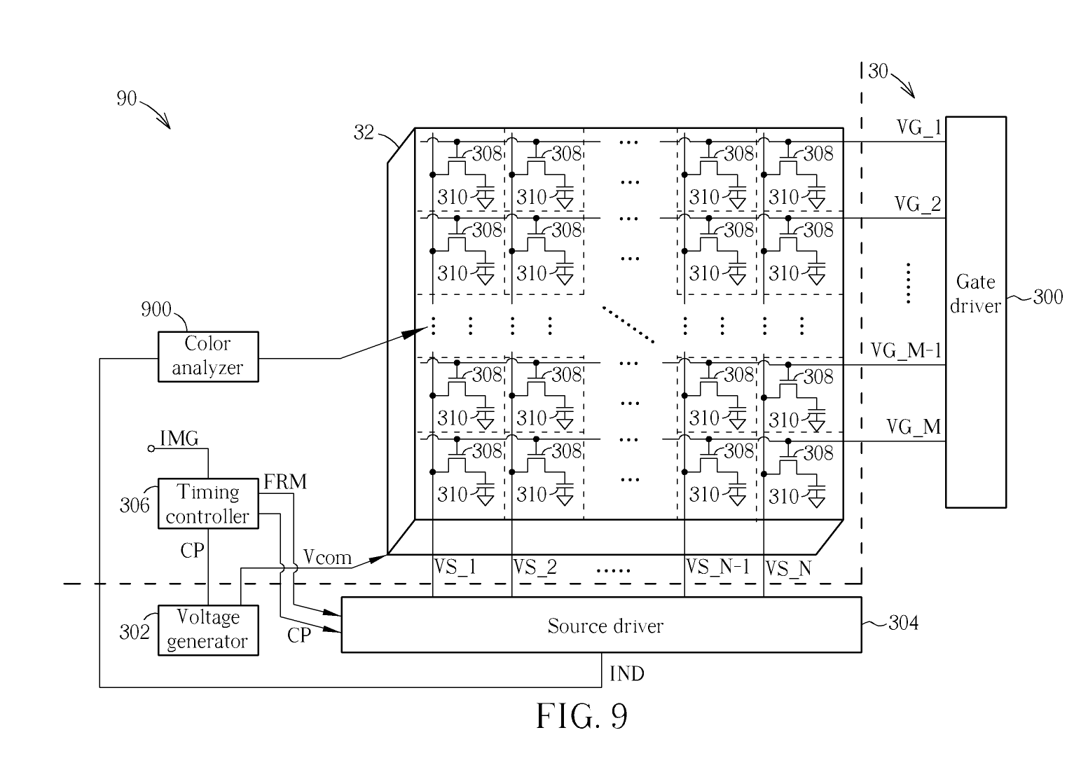

In order to integrate the driving device 30 in practical circuits, the present invention further provides a display device 90, as illustrated in FIG. 9. Other than the driving device 30 and the LCD panel 32, the display device 90 further includes a color analyzer 900 for measuring the flicker amplitude of the pixel units on the LCD panel 32 to generate the compensation indication signal IND.

In the prior art, the LCD monitor 10 adjusts the common signal Vcom by the voltage generator 106 to compensate the flicker effect of the LCD panel 100. During the compensation period, the power supply circuit has to provide various levels of positive and negative voltages, implying that architecture of the power supply circuit is very complex, such that the cost of the LCD monitor 10 can not be effectively reduced. In comparison, the present invention compensates the flicker effect of the LCD panel 32 by adjusting the source driving signals VS_1-VS_N, instead of adjusting the common signal Vcom. As a result, the power supply circuit no longer has to provide any negative voltage to the LCD panel 32, so as to effectively simplify the complexity of the power supply circuit and reduce cost thereof.

To sum up, the present invention compensates the flicker effect of the LCD panel by adjusting the source driving signal to simplify the power supply circuit of the LCD monitor.

Those skilled in the art will readily observe that numerous modifications and alterations of the device and method may be made while retaining the teachings of the invention.

What is claimed is:

1. A driving device for driving an LCD panel, the LCD panel comprising a substrate and a plurality of pixel units arranged as a matrix on the substrate, the driving device comprising:
a gate driver coupled to the plurality of pixel units for generating a plurality of scanning signals, each for driving pixel units of a row of the LCD panel;
a voltage generator coupled to the substrate for providing a non-negative common signal to the substrate according to a conversion period signal; and
a source driver coupled to the LCD panel for generating a plurality of source driving signals according to a compensation indication signal, a frame signal and the conversion period signal, each source driving signal for driving pixel units of a column of the LCD panel;
wherein the compensation indication signal is utilized for indicating whether to compensate a flicker amplitude of the plurality of pixel units.

2. The driving device of claim 1, wherein the source driver comprises:
a compensation control device for generating a first bias signal and a second bias signal according to the compensation indication signal;
a high-potential regulator coupled to the compensation control device for adjusting and stabilizing a high-potential voltage;
a low-potential regulator coupled to the compensation control device for adjusting and stabilizing a low-potential voltage; and
a plurality of gamma voltage generators, each coupled to the high-potential regulator and the low-potential regulator, for generating the corresponding source driving signal according to the high-potential voltage, the low-potential voltage, the conversion period signal and a corresponding pixel content signal in the frame signal.

3. The driving device of claim 2, wherein each of the plurality of gamma voltage generators comprises:
a voltage divider coupled to the high-potential regulator and the low-potential regulator for generating a plurality of divided voltages according to the high-potential voltage and the low-potential voltage;
a selection circuit coupled to the voltage divider for periodically selecting one of the plurality of divided voltages according to the pixel content signal and the conversion period signal to generate a selection result; and
a first buffer amplifier coupled to the selection circuit for buffering the selection result to generate the corresponding source driving signal.

4. The driving device of claim 1, wherein the voltage generator comprises:
a multiplexer coupled to a high-potential common voltage and a low-potential common voltage for periodically selecting the high-potential common voltage or the low-potential common voltage according to the conversion period signal to generate a switch signal; and
a second buffer amplifier coupled to the multiplexer for buffering the switch signal to generate the common signal.

5. The driving device of claim 4, wherein the low-potential common voltage is a ground voltage.

6. The driving device of claim 1, wherein the source driver compensates the flicker amplitude when the compensation indication signal indicates that the flicker amplitude exceeds a default threshold.

7. A display device comprising:
an LCD panel comprising:
a substrate; and
a plurality of pixel units arranged as a matrix on the substrate;
a color analyzer coupled to the LCD panel for measuring a flicker amplitude of the plurality of pixel units to generate a compensation indication signal;
a timing controller for receiving image data to generate a frame signal and a conversion period signal; and
a driving device for driving the LCD panel, the driving device comprising:
a gate driver coupled to the plurality of pixel units for generating a plurality of scanning signals, each for driving pixel units of a row of the LCD panel;
a voltage generator coupled to the substrate and the timing controller for providing a non-negative common signal to the substrate according to the conversion period signal; and
a source driver coupled to the color analyzer, the timing controller and the LCD panel for generating a plurality of source driving signals according to the compensation indication signal, the frame signal and the conversion period signal, each of the plurality of source driving signals for driving pixel units of a column of the LCD panel.

8. The display device of claim 7, wherein the source driver comprises:
a compensation controller coupled to the color analyzer for generating a first bias signal and a second bias signal according to the compensation indication signal;
a high-potential regulator coupled to the compensation controller for adjusting and stabilizing a high-potential voltage according to the first bias signal;
a low-potential regulator coupled to the compensation controller for adjusting and stabilizing a low-potential voltage according to the second bias signal; and
a plurality of gamma voltage generators, each coupled to the high-potential regulator, the low-potential regulator and the timing controller for generating the corresponding source driving signal according to the high-potential voltage, the low-potential voltage, the conversion period signal and a corresponding pixel content signal in the frame signal.

9. The display device of claim 8, wherein each of the plurality of gamma voltage generators comprises:
a voltage divider coupled to the high-potential regulator and the low-potential regulator for generating a plurality of divided voltages according to the high-potential voltage and the low-potential voltage;
a selection circuit coupled to the voltage divider and the timing controller for periodically selecting one of the plurality of divided voltages according to the pixel content signal and the conversion period signal to generate a selection result; and
a first buffer amplifier coupled to the selection circuit for buffing the selection result to generate the corresponding source driving signal.

10. The display device of claim 7, wherein the voltage generator comprises:
a multiplexer coupled to a high-potential common voltage and a low-potential common voltage for periodically selecting the high-potential common voltage or the low-potential common voltage according to the conversion period signal to generate a switch signal; and
a second buffer amplifier coupled to the multiplexer for buffing the switch signal to generate the common signal.

11. The display device of claim 10, wherein the low-potential common voltage is a ground voltage.

12. The display device of claim 7, wherein the source driver compensates the flicker amplitude when the compensation indication signal indicates that the flicker amplitude exceeds a default threshold.
